(19) United States
(12) Patent Application Publication
(10) Pub. No.: US 2006/0008374 A1
(43) Pub. Date: Jan. 12, 2006

(54) Vane-type rotary apparatus with split vanes

(76) Inventors: John Robertson, Richmond (CA); Patrick Badgley, Columbus, IN (US); Brian Cherry, Richmond (CA)

Correspondence Address: BERENATO, WHITE & STAVISH, LLC, 6550 ROCK SPRING DRIVE, SUITE 240, BETHESDA, MD, 20817, US

(21) Appl. No.: 10/888,495

(22) Filed: Jul. 12, 2004

(51) Int. Cl. F01C 19/00; F03C 2/00; F03C 4/00

(52) U.S. Cl. 418/111; 418/110

(57) ABSTRACT

A rotary apparatus includes a stationary stator having an internal cylindrical chamber. A rotor is rotatably mounted in the chamber. There are cam-like annular surfaces on the stator to each side of the rotor. A plurality of vane assemblies are slidably mounted on the rotor. The vane assemblies each have two outer ends. These slidingly engage the cam-like annular surfaces, whereby gases between the vane assemblies are compressed and expand between the cam-like surfaces and the rotor as the rotor and vanes rotate relative to the stator. Preferably each of the vane assemblies has two separate components, each outer end being on one of the components. The apparatus has a conduit for conducting compressed gases between the two components of each of the vane assemblies and thereby biasing each of the components towards one of the cam-like annular surfaces. Preferably there is an intake system for intaking gases between the vane assemblies and between the cam-like surfaces and the rotor and an exhaust systems for conducting exhaust gases away from the spaces. Each of the intake and exhaust systems preferably includes a reed valve. There may be a rotatable annular housing within the stator between the stator and the rotor. The components of the vane assemblies engage the housing, the housing rotating with the rotor and the vane assemblies.

### BACKGROUND OF THE

This invention relates to vane-type rotary apparatuses, such as engines, and, in particular, to vane-type rotary apparatuses with split vanes having two separate components contacting cam-like surfaces on each side of a stator. The invention also relates to vane-type rotary apparatuses having a rotatable annular housing within the stator between the stator and the rotor, the components of the vane assemblies slidably engaging the housing, the housing rotating with the rotor and the vane assemblies.

Many different types of rotary engines have been suggested in the past and have been covered by a large number of patents. Only a relatively small number of these have been thoroughly tested. Many rotary engines are appealing on paper, but practical difficulties arise when prototypes are constructed.

The best-known rotary engine is the Wankel engine which has been in volume production in Mazda automobiles. Even this engine has had considerable difficulties with proper sealing of the rotors, although such problems have been largely overcome. However the engine is not particularly efficient and high fuel consumption has been a characteristic of vehicles using this technology.

Another type of rotary engine is the axial vane type. This type of engine has a cylindrical rotor within a cylindrical chamber in a stator. A plurality of blade-like vanes extend slidably through the rotor, parallel to the axis of rotation. There are undulating cam surfaces on each side of the rotor. High portions of the cam surface on one side align with low portions of the cam surface on the other side such that the vanes are caused to reciprocate back and forth in the axial direction as the rotor rotates.

One such engine is found, for example, in U.S. Pat. No. 4,401,070 to James Lawrence McCann. This type of engine compresses gases forwardly of each vane in the direction of rotation as the rotor rotates. The compression occurs as the vane moves from a low cam surface, relatively distant from the rotor, to a high cam surface relatively close to the rotor. After the gases are compressed, they must be transferred to the rearward side of each vane prior to combustion so that the ignited gases will propel the rotor forwards.

The need for transferring the compressed gases is removed in a variation of this type of rotary engine such as found in Polish Patent Number 38112 to Czyewski. In this case the gases are compressed between adjacent vanes which are angularly spaced-apart much closer than in the McCann engine. The gases are compressed as each pair of adjacent vanes moves towards a high cam area. Expansion of the ignited gases is permitted, and the propulsion force created, as the vanes continue to move past the high cam area to a relatively low cam area after ignition.

This type of rotary engine offers many potential advantages including high-efficiency, simple construction and light weight. However, while the theoretical possibility of such an engine has been suggested in the past, many practical difficulties have inhibited development of such engines beyond the stage of a working prototype. For example, considerable time and effort have been expended trying to develop practical sealing systems between the vanes, the rotor and the stator of such an engine.

Prior art rotary engines of this type typically have the radially outer edges of the vanes in sliding contact with the cylindrical inner wall of the stator. It has been difficult to insure both proper sealing between the vanes and the stator and, at the same time, deal with potentially high wear between the vanes and the wall of the stator or the seals and the wall of stator.

Another problem has been the axially outer edges of the vanes which are in sliding contact with the surfaces of the cams. Again it has been difficult to insure proper sealing on both sides of the rotor and deal with wear which inevitably occurs between the edges of the vanes, or the seals, and the cam surfaces.

The third area where difficulties have occurred is in delivering intake gases, such as an air/fuel mixture, to the spaces defined between the vanes and between the cams and the rotor. Likewise difficulties have occurred in providing for proper passage of exhaust gases from the spaces. Such means needs to be both efficient in transferring gases as well as being reliable in operation and simple and economical in construction.

Accordingly, it is an object of the invention to provide an improved rotary apparatus which improves sealing and reduces wear between radially outer edges of the vanes and the stator.

It is also an object of the invention to provide an improved rotary apparatus which improves sealing and reduces wear between axially outer edges of the vanes and the cam surfaces.

It is a still further object of the invention to provide an improved rotary apparatus with an efficient intake means for conducting intake gases to spaces between the vanes and between the cam-like surfaces and the rotor and improved exhaust means for conducting exhaust gases away from the spaces.

### SUMMARY OF THE INVENTION

In accordance with these objects, there is provided a rotary apparatus comprising a stationary stator having an internal cylindrical chamber and a rotor rotatably mounted in the chamber. There are cam-like annular surfaces on the stator to each side of the rotor. A plurality of vane assemblies are slidably mounted on the rotor. The vane assemblies each have two outer ends which slidably engage the cam-like annular surfaces, whereby gases between the vane assemblies are compressed and expand between the cam-like surfaces and the rotor as the rotor and vanes rotate relative to the stator. Each of the vane assemblies has two separate components. Each outer end is on one of the components. The apparatus has a conduit for conducting compressed gases between the two components of each of the vane assemblies and thereby biasing each of the components toward one of the cam-like annular surfaces.

According to another aspect of the invention, there is provided a rotary apparatus comprising a stationary stator having an internal cylindrical chamber and a rotor rotatably mounted in the chamber. There are cam-like annular surfaces on the stator to each side of the rotor. A plurality of vane assemblies are slidably mounted on the rotor. The vane assemblies each have two outer ends which slidably engage the cam-like annular surfaces, whereby gases between the vane assemblies are compressed and expand between the cam-like surfaces and the rotor as the rotor and vanes rotate relative to the stator. There is a rotatable housing within the stator between the stator and the rotor, the vane assemblies slidably engaging the housing. The housing rotates with the rotor and the vane assemblies. Preferably radially outer edges of the vane assemblies slidably engage the housing.

According to a further aspect of the invention, there is provided a rotary apparatus comprising a stationary stator having an internal cylindrical chamber and a rotor rotatably mounted in the chamber. There are cam-like annular surfaces on the stator to each side of the rotor. A plurality of vane assemblies are slidably mounted on the rotor. The vane assemblies each have two outer ends which slidably engage the cam-like annular surfaces, whereby gases between the vane assemblies are compressed and expand between the cam-like surfaces and the rotor as the rotor and vanes rotate relative to the stator. There is intake means for intaking gases to spaces between the vane assemblies and between the cam-like surfaces and the rotor and exhaust means for exhausting gases away from the spaces. Each of the intake and exhaust means includes a one-way valve. For example each one-way valve may be a reed valve.

### BRIEF DESCRIPTION OF THE DRAWINGS

FIG. 1 is a simplified, longitudinal section of a rotary device according to an embodiment of the invention;

FIG. 2 is a simplified side view of the rotor thereof;

FIG. 3 is a view similar to FIG. 1 of another embodiment, showing the intake means and exhaust means thereof;

FIG. 4 is a side view thereof;

FIG. 5 is an unrolled, plan view showing the vane assemblies and cam surfaces thereof;

FIG. 5a is an isometric view of one of the vane assemblies thereof;

FIG. 6 is an isometric view of one rotor half of a further embodiment of the invention, showing the internal construction thereof;

FIG. 7 is an isometric view of the rotor half of FIG. 6, showing the exterior construction thereof;

FIG. 8 is an interior elevational view of the rear cam assembly thereof;

FIG. 9 is an isometric view of the rear housing thereof;

FIG. 10 is an isometric view of one of the cams thereof;

FIG. 11 is an isometric view of the outer housing of the stator;

FIG. 12 is an isometric view of the drive cam housing thereof;

FIG. 13 is an isometric view of the rear cam housing thereof;

FIG. 14 is an isometric view of the rotatable, annular housing thereof;

FIG. 15 is another isometric view of the housing of FIG. 14;

FIG. 16 is an isometric view of one of the vanes thereof;

FIG. 17 is an isometric view of the drive shaft thereof;

FIG. 18 is an isometric view of the intake reed valves thereof;

FIG. 19 is an isometric view of one of the exhaust reed valves thereof;

FIG. 20 is an isometric view of the coalescer housing thereof;

FIG. 21 is simplified isometric view, partly broken away, of a rotary device according to another embodiment of the invention;

FIG. 22 is an isometric view of the housing assembly thereof;

FIG. 23 is an isometric view of a two piece vane thereof,

FIG. 24 is an isometric view of a four piece vane;

FIG. 25 is an isometric view, partly broken away, of the device of FIG. 21; and

FIG. 26 is an exploded perspective view of the rotary apparatus of FIG. 1.

### DETAILED DESCRIPTION OF THE PREFERRED EMBODIMENTS

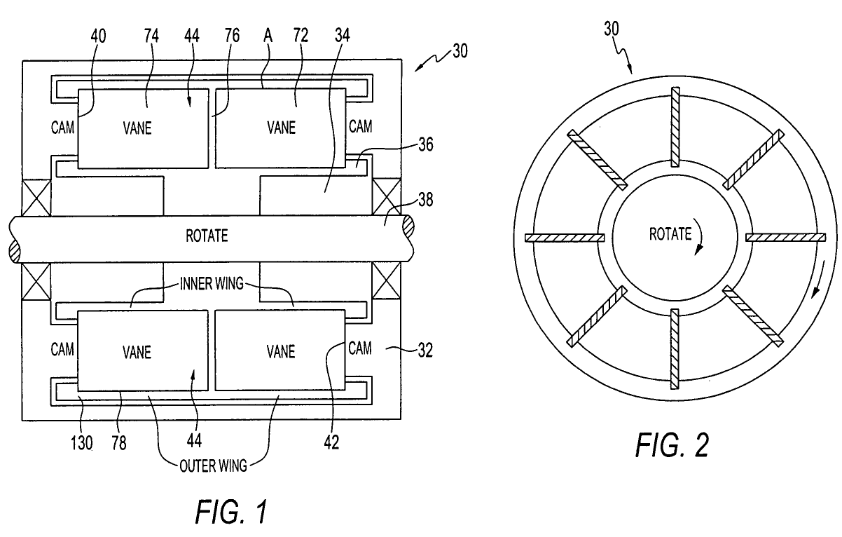

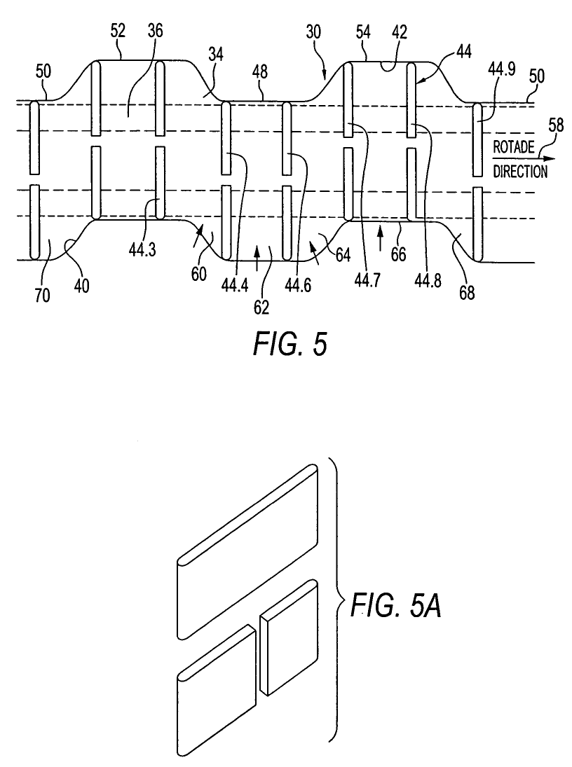

Referring to the drawings and first to FIG. 1 and FIG. 5, these show a vane-type rotary engine 30 according to an embodiment of the invention. It should be understood however that the invention is also applicable to other types of rotary devices such as compressors, expanders, pumps and external combustion engines with suitable modifications as will be understood by someone skilled in the art. As is typical with such rotary devices, engine 30 has a stationary stator 32 with an internal cylindrical chamber 34. A rotor 36 is rotatably mounted in the chamber by means of a drive shaft 38. There are cam-like annular surfaces 40 and 42 on the stator to its side of a rotor.

A plurality of vane assemblies, shown generally at 44, are slidably mounted on the rotor such that the vane assemblies reciprocate from side to side with respect to the rotor, as the rotor rotates relative to the stator, as may be best appreciated by comparing the different positions of the vane assemblies in FIG. 5.

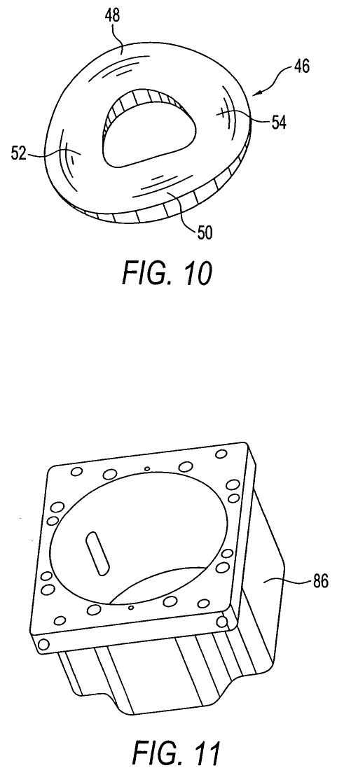

Each cam surface has an undulating nature as may be appreciated from FIG. 5 and FIG. 10 which shows one of cams 46. Each cam has two relatively high portions 48 and 50 and two relatively low portions 52 and 54. Thus gases between adjacent vane assemblies on each side of the rotor, and between the rotor and the cam surfaces, are alternatively compressed and expand as the rotor rotates. For example, with reference to FIG. 5, gases are compressed the maximum amount between vane assemblies 44.4 and 44.6 at the top of FIG. 5 as the vanes pass over the high portion 48 of the cam surface. The gases are expanded the maximum amount between vane assemblies 44.7 and 44.8 at the top of FIG. 5 when these vane assemblies pass over relatively low portion 54 of the cam surface.

With reference to FIG. 5, the rotor 36 rotates to the right, from the point of view of this drawing, as indicated by arrow 58. Intake occurs at 60, between vane assemblies 44.3 and 44.4, for example, at the bottom of the figure. Maximum volume occurs between vane assemblies 44.4 and 44.6 at 62. Compression of the gases occurs at 64 between vane assemblies 44.6 and 44.7. Maximum compression occurs at 66 between vane assemblies 44.7 and 44.8. The mixture of fuel and air is ignited, either by compression or by an ignitor such as a spark plug, and the subsequent expansion or power stroke occurs at 68 between vane assemblies 44.8 and 44.9. The exhaust gases are exhausted when the vane assemblies reach the next space 70. This cycle is known in the prior art and accordingly is not described in more detail.

In prior art engines of this type, each vane assembly comprised a single vane with two axial ends, each of which slidingly engaged one of the cams. However in this embodiment of the invention each vane assembly includes two separate components 72 and 74 as shown in FIG. 1. These are separated by a space 76. Compressed gases in the space due to discharge of gas from the apparatus, as explained below, bias the two components of the vane assembly outwardly away from the space towards the cams 40 and 42. Alternatively the two components of the vane assembly may be biased outwardly by a spring, another resilient member or some other biasing means. Thus proper sealing between the axially outer ends of the vanes and the cams is insured even after wear occurs on either or both components.

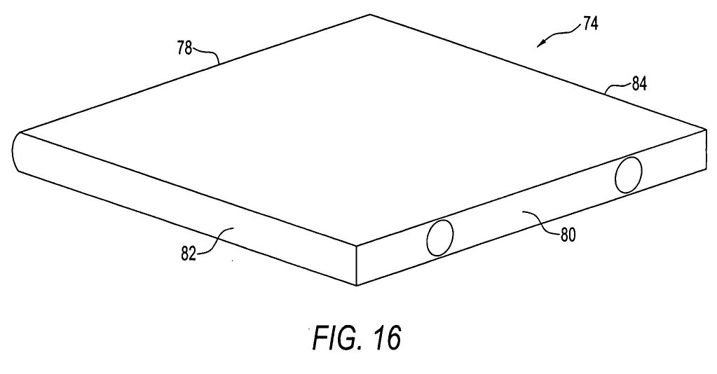

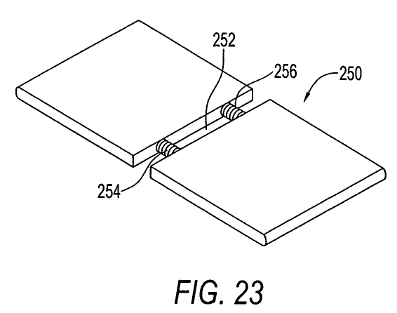

Each vane component has a axially outer end 78, a axially inner end 80, an radially inner end 82 and an radially outer end 84 as seen for component 74 in FIG. 16. Two holes generally referred to as 75 in FIG. 16 are to house spring members 254 and 256 best shown in FIG. 23.

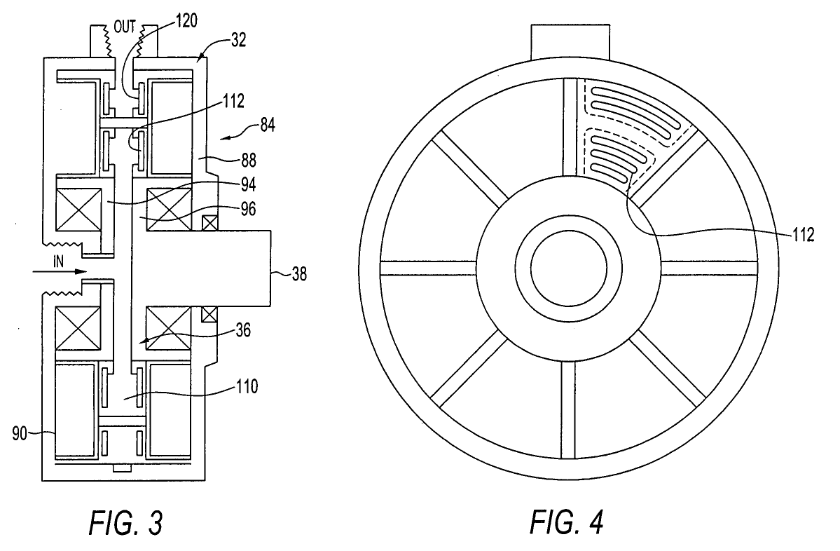

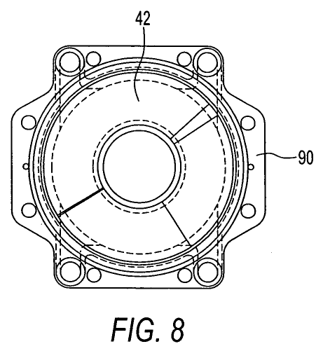

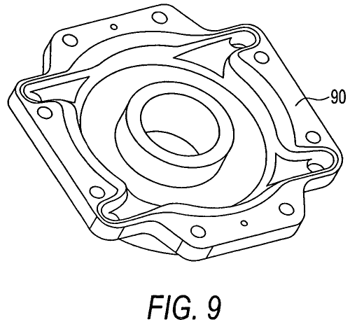

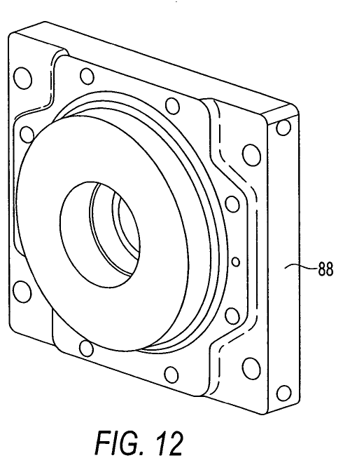

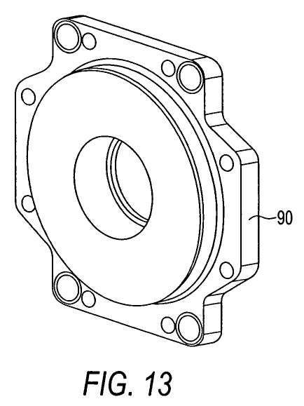

FIG. 3-5a show engine 84 which is generally similar to engine 30. Like parts have like numbers. Stator 32 includes an outer housing 86, shown best in FIG. 11, a drive housing 88, shown best in FIG. 12 and a rear housing 90 shown best in FIGS. 8, 9 and 13. The cams 40 and 42 fit inside the drive housing and rear housing as shown for cam 42 and housing 90 in FIG. 8.

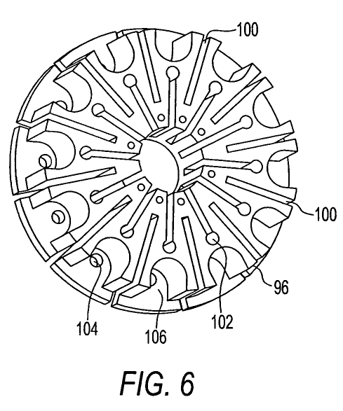

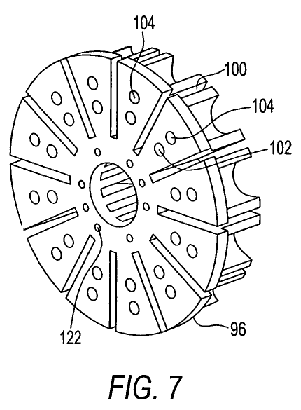

Rotor 36 is in two halves 94 and 96 as shown in FIG. 3. Rotor half 96 is shown in better detail in FIGS. 6 and 7 which illustrate a third embodiment. Rotor half 94 is a mirror image. In this example the engine has twelve vane assemblies, each of which is slidably received in a slot 100 in each of the rotor halves. The slots 100 in the two rotor halves are aligned such that the two components of each main assembly are aligned.

Each rotor half has two sets of twelve openings. Openings 102 are for providing intake gases to the spaces between the vanes and between the rotor and the cams. Openings 104 are for exhausting exhaust gases from spaces 106 where the mixture is ignited and expands to propel the rotor. There is a seal between the intake and exhausting regions of the rotor.

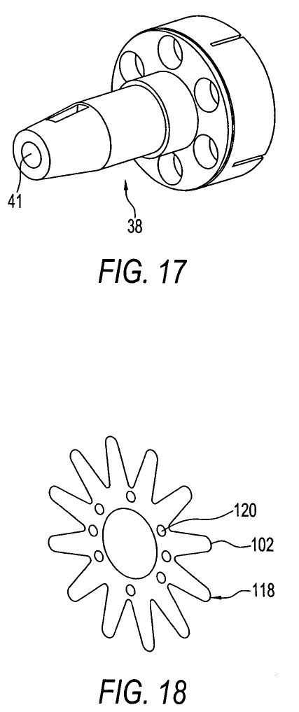

The rotor halves are mounted on drive shaft 38 shown in better detail in FIG. 17. There is a passageway 41 through the drive shaft which serves a conduit for a fuel/air mixture as seen in FIG. 3, the passageway 41 communicates with space 110 between the two halves of the rotor and between the components of each of the vane assemblies.

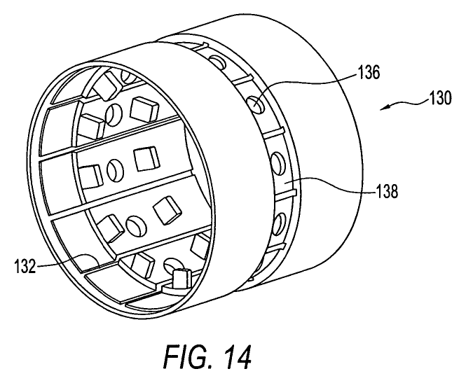

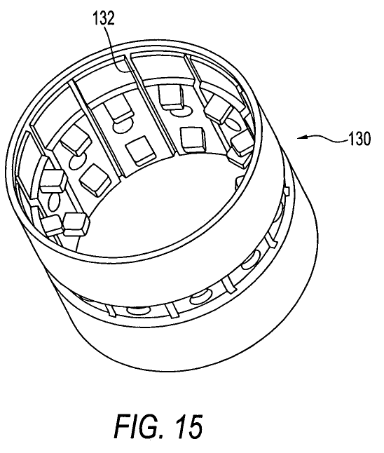

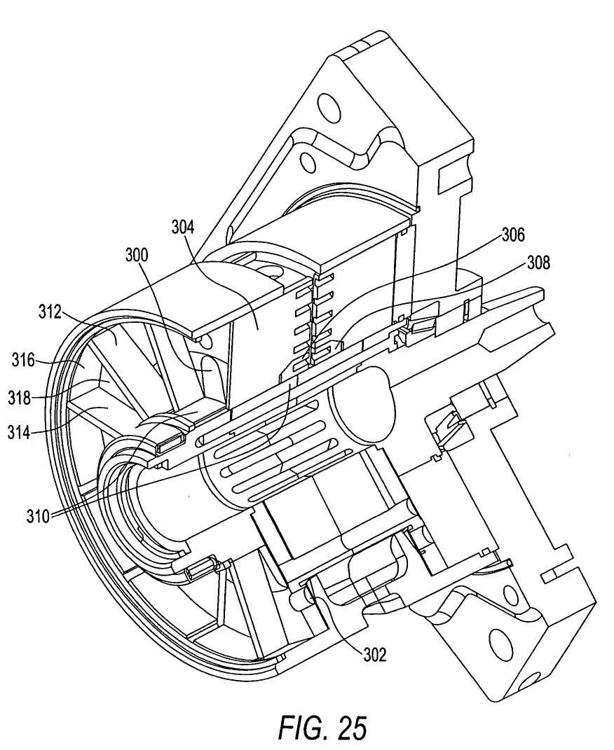

A plurality of intake reed valves 112, twelve in the case of the embodiment of FIGS. 6-20, are disposed over the openings 102 shown in FIGS. 6 and 7. These are formed by a single spider member 118 shown in FIG. 18. This member is made of a relatively thin sheet metal and one member is connected to each of the rotor halves by fasteners extending through openings 120 in the spider member and openings 122 in the rotor halves. The mounting of the intake reed valves in relation to the rotor and vane assembly is further illustrated in FIG. 25 where a single leg 300 of spider member 118 is shown. The intake reed valves are open when the pressure of intake gases exceeds pressure in the spaces between the vanes and the cam surfaces. The intake reed valves allow the intake gases to then enter the spaces prior to compression and ignition. The intake reed valves are held in place by a slip ring.

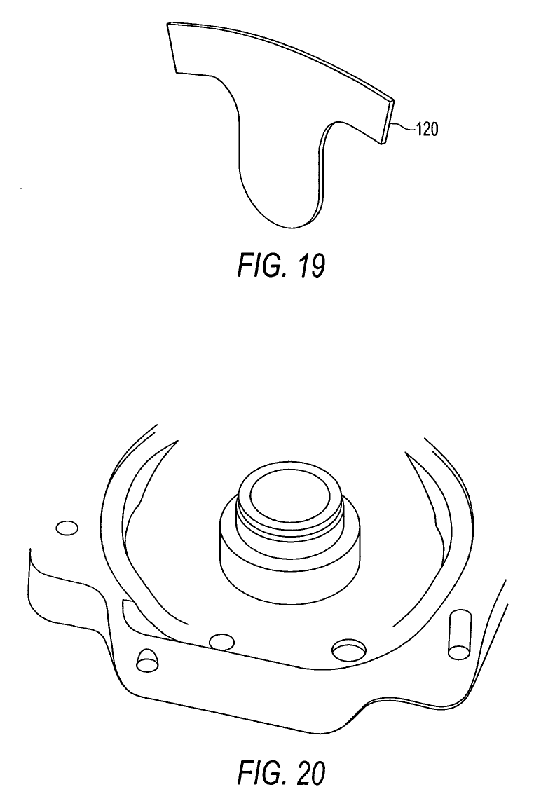

There is also a set of exhaust reed valves 124, twelve in the case of the embodiment of FIGS. 6-20, for each of the rotor halves, each covering one of the openings 104. One of these reed valves are shown in detail in FIG. 19. The exhaust reed valves are configured to open when the pressure in the spaces between the vanes and the cams is greater than the pressure in space 110 between the rotor halves. The exhaust reed valves are held in place by a slip ring.

Rotary engines according to the invention also differ from the prior art in that a rotatable annular housing 130, shown in FIGS. 1,14 and 15, is located between the stator and the rotor. This housing includes a plurality of slots 132, 1 for each of the vane assemblies. Thus the housing has twelve slots for the embodiment of FIGS. 6-20. Thus the radially outer ends 78 of the vane assemblies are slidably received in the slots 132 and rotate with the housing instead of sliding on the cylindrical inner surface of the stator as in the prior art.

Exhaust gases pass radially outwards from the housing 130 through openings 136 into a groove 138 extending about the housing.

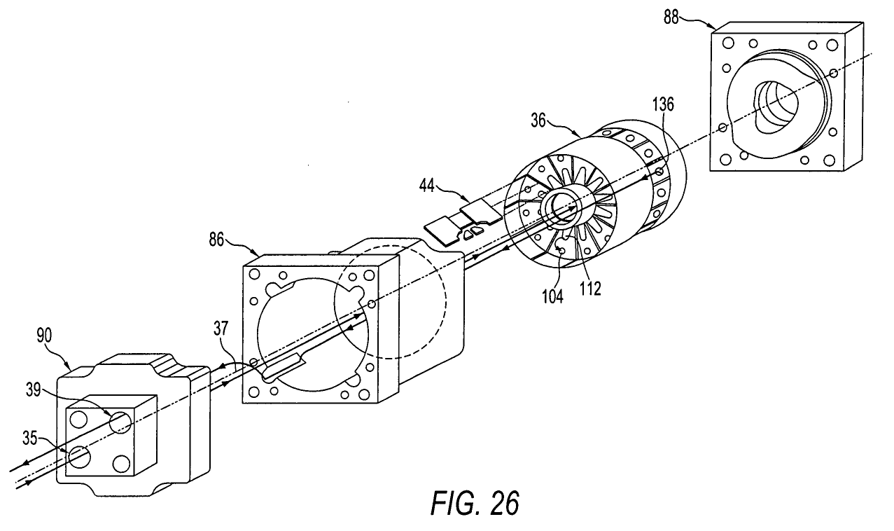

FIG. 26 shows in greater detail the path taken by the intake fluid/air mixture and outlet exhaust. The fluid/air mixture enters the rotor apparatus via intake port 35 and travels along centerline 37 to the rotor 36. By the centrifugal pumping action the fluid/air mixture enters the working chamber via inlet valve 112. After combustion when the outlet pressure is less than the pressure in the working chamber, the exhaust leaves the working chamber by hole 104. Again by centrifugal action, the exhaust finds its way to the periphery where it exits the rotor 36 via hole 136. The exhaust than leaves the rotor apparatus by exhaust port 39.

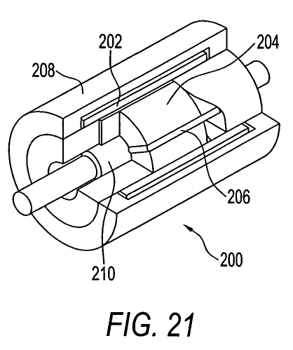

Referring to FIG. 21, this shows a rotary device 200 according to another embodiment of the invention. This device eliminates the high rubbing velocities normally encountered between rotating vanes and the fixed outer housing of rotary engines of this type. This is accomplished by rotating the outer housing along with the vanes and rotor. In earlier rotary engines with reciprocating vanes, the rotational speed of the rotor produces a high sliding velocity of the vanes against the outer housing. Centrifugal force throws the vanes outward and generates a very large load between the vanes and the stator. The combination of high rubbing velocity and high load and generates a relatively large frictional force at the vane and stator interface.

By comparison, with reference to FIG. 21, a rotating sleeve 202 (wing) is attached to the outer diameter of rotor 204. Centrifugal force throws the vanes 206 up against this sleeve. However, in this configuration, the rotary motion of the rotor and vanes does not cause any relative velocity between the vanes and the sleeve as they are rotating together. There is a small relative velocity due to the axial motion of the vanes following the profile of the cams. This velocity is an order of magnitude smaller than the velocity found in the normal configuration. Stator 208 encloses the rest of the mechanism shown in FIG. 21.

By making the sleeve integral with the rotor, leakage between the rotor and the stator and between the vane and the stator is eliminated. In the conventional engine configuration it is necessary to add seals between the rotor and the stator to control the amount of leakage in this area. The seals are difficult to make because of the high rubbing velocity in this area and because the outer diameter of the rotor is interrupted by vane slots.

The rotary device of FIG. 21 also has an inner housing or sleeve 210 which rotates with the rotor as opposed to the conventional engine. By making the inner housing integral with the rotor the possibility of leakage between the inner housing and the rotor is eliminated. This eliminates a large number of sealing elements that are required with the normal configuration.

In summary, the invention improves over the prior art by attaching a sleeve or rotatable housing to the outer diameter of the rotor such that it functions as an integral part of the rotor, rotating with the rotor and sealing the interface between the sleeve and the rotor. Also, the invention improves over the prior art in this embodiment by attaching a rotatable inner housing to the rotor such that the inner housing rotates with the rotor and seals the interface between the inner housing and the rotor. The housing can be made as an integral part of the rotor.

The invention eliminates the rotating relative motion between the rotor and the stator and significantly reduces wear and friction. Leakage between the rotor and stator is eliminated to along with the need for seals in this area. Leakage between the inner portion of the stator and the face of the rotor is also eliminated along with the need for seals in this area.

The invention, as illustrated in the embodiment of FIG. 21, is applicable to various rotary devices including engines, compressors, pumps and expanders.

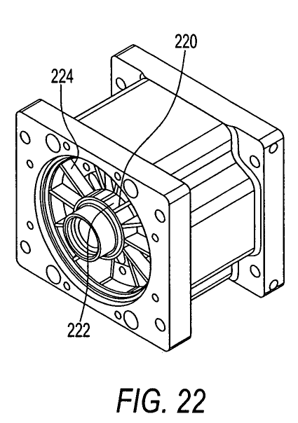

Referring to FIG. 22, this shows an improvement to the version of the invention shown in FIG. 21, that consists of adding axial grooves 226 to the inner diameter of the outer sleeve and axial grooves 220 to the outer diameter of the inner sleeve 222 such that the vanes 224 ride in these slots. The sides of the slots are the same width as the vane slots in the rotor such that the vanes can push against the sides of the slots and thus provide a sealing surface.

In a conventional engine, and the version of FIG. 21, the vanes are thrown outward by centrifugal force, generating a gap between the outer diameter of the inner sleeve and the bottom surfaces of the vanes. This gap is a leakage path which must otherwise be sealed by adding additional sealing components in the absence of the grooves. The grooves also serve to prevent bending of the vanes due to pressure differences between the leading and trailing faces of the vane. FIG. 22 illustrates the support and sealing grooves.

In summary, the version of FIG. 22 improves over the previous embodiment by providing radial grooves in the rotating inner and outer housings. The vanes move axially in these grooves. Alternatively, there may be radial grooves in only the rotating inner housing with the outer housing having no grooves. This reduces manufacturing costs.

The sealing grooves eliminates gaps that can form between the vanes and the outer and inner housings by providing a face seal for the vane against the sides of the grooves. This improves sealing and reduces leakage. The grooves eliminate seals on the radially inner and outer edges of the vanes. The axial grooves support the vanes to reduces vane deflection caused by pressure differences from one side of the vane to the other. Like the previous embodiment, this embodiment is applicable to engines, compressors, pumps, expanders and other types of rotary devices.

FIG. 23 illustrates a two piece vane 250 for use in the rotary devices described above. In the case of compressors and pumps, outlet pressure can be routed to the space 252 to pressure load the vanes against the faces of the cans. Spring members 254 and 256 are inserted between the vane halves to provide initial preload to force the vanes against the cams before the outlet pressure is developed.

In summary, this embodiment of the invention consists of splitting the vanes vertically into two parts so that the vane surface that contacts the cam always contacts on both cam surfaces. A one-piece vane can only contact on one cam at the time. Applying outlet pressure to the space between the two vane halves pressure loads the vanes against the cam surfaces. Installing spring type elements between the two vane halves loads them against the cam surfaces.

This embodiment allows the cams to continuously seal against the cam surfaces and thus eliminates the need for seals in this interface. By applying outlet pressure to the space between the two cam surfaces, the invention ensures that they are pressed against the cam surfaces regardless of the pressures in the working chambers of the rotary device. Referring to FIG. 25, the working chamber being the region in space defined by a rotor half 318, the cam (not shown), the inner housing 310, the outer housing 316 and two vanes 312 and 314. Using a spring to preload the two vane halves against the cam surfaces ensures that there is contact, and thus good sealing, prior to the generation of outlet pressures and also at low outlet pressures. The spring force is set to overcome the axial acceleration forces imposed on the vane halves at full operating speeds, thus ensuring good sealing at all times. This embodiment provides for wear compensation of the vane and cam surfaces. As these parts wear the gap between the two vane halves increases. This aspect of the invention is applicable to compressors, pumps and expanders. It is not applicable to engines since their outlet pressure is very low and the pressures in the working chambers are very high.

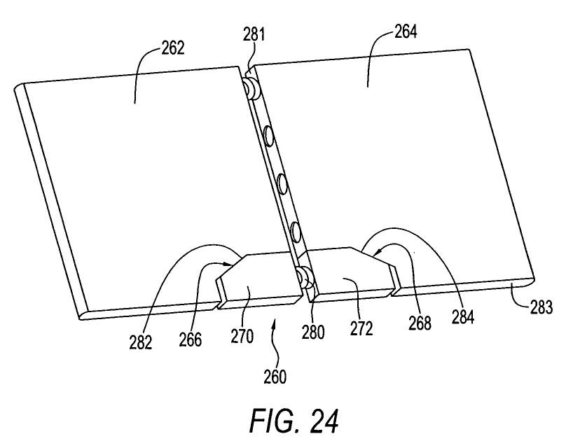

Referring to FIG. 24, this shows a vane 260 where each vane half 262 and 264 has a recess 266 and 268 formed along its radially inner edge with a triangular seal piece 270 and 272 installed in the recess. The purpose of each seal piece is to eliminate leakage between the radially inner edge of the vane and the inner housing. Output pressure, and a preloading spring 280 force the seal pieces against a sloped part 282 and 284 of each vane half so that the seal piece is also forced inward to press against the inner housing. The assembly shown in FIG. 25 illustrates the mounting of the vane 304 with seal pieces 306 and 308 mounted flush with inner housing 310.

In summary, this aspect of the invention consists of a vane 260 in two pieces 262 and 264 that are loaded against the sloped or inclined part of the vane half such that the seal piece 270 or 272 can move radially inward and seal against the inner housing. This aspect of the invention is also applicable to either a stationary or rotating (sleeved) inner housing with or without vane sealing and support grooves.

The outlet pressure is applied to the space 281 between the two seal pieces to load them against the sloped parts of the vane and thus to the inner housing. The resilient spring 280 is inserted between the two seal pieces to provide pre-loaded such that each seal is loaded against the inner housing when outlet pressure is present.

Each seal piece closes the gap between the bottom or inward inside 285 and 287 of the vane seal pieces and the outer diameter of the inner housing (or the bottom of the sealing and support grooves). This improves sealing in this area and helps to eliminate leakage. The sloped interface allows seal to move axially and radially to compensate for wear of the outer housing (or sleeve), the vane, the seal piece and the inner housing. As any of these components wear the gap between the two seal pieces increases. This aspect of the invention is applicable to compressors or pumps as well as expanders.

Referring to FIG. 25, this shows a further aspect of the invention which is applicable to compressors and pumps. The invention consists of replacing the inlet and/or output ports used on conventional rotary engines of this type with read type valves located in the rotor. FIG. 25 shows an inlet reed valve 300 and an exhaust reed valve 302. Each of these valves is a thin sheet metal piece located over holes communicating with the working chambers of the rotary engine. FIG. 18 illustrates the inlet reed valve 118 and FIG. 19 illustrates the exhaust reed valve 124. When the valves are placed on the working chamber side of these holes the valve is an inlet valve. Any time that the inlet pressure is higher than the pressure in the chamber the valve bends open as a result of this differential pressure and the inlet fluid flows into the chamber. When the chamber volume starts to decrease the pressure in the chamber will exceed the inlet pressure and the inlet valve will close.

A second series of thin sheet metal valves, including valve 302, are placed on the outward side of a series of holes communicating with the working chambers. These holes are further illustrated in FIG. 6 as shown generally by reference 104. When the pressure in each working chamber exceeds the outlet pressure the valve bends and allows the working fluid to flow out of the working chamber into the outlet passage.

The use of reed type inlet and outlet valves on a positive displacement compressor or pump is very common. However the unique feature here is that these valves have been placed in the rotor of a rotory engine of this type. This location permits the inlet flow to be brought through a hollow rotor and shaft and benefit by the centrifugal pumping action which is inherent in the design. The fluid enters on the center line of the rotor and flows radially outward to reach the valve port. The centrifugal pumping effect raises the pressure of the inlet fluid before it reaches the inlet valve. Similarly the outlet flow goes through the exhaust valve in the face of the rotor and flows into a hollow cavity in the outer portion of the rotor. It exhausts from this cavity through the outer diameter of the rotor. The movement of the fluid from a given diameter (outer port) to the periphery of the rotor (rotor diameter) generates a centrifugal pumping effect which raises the outlet pressure. FIG. 25 represents a compressor incorporating the features described above.

In summary, this aspect of the invention consists of reed type inlet valves located in the face of a rotor of a rotory device of this class. There are individual valves for each working chamber. For example, a rotory device with eight vanes would have sixteen valves, eight on each side.

Inlet reed valves are located on the face of the rotor such that the intake flow comes through a hollow shaft and flows outward radially to the valves such that the pressure at the valve is higher than the pressure in the shaft due to centrifugal pumping action.

The invention also includes the feature of having reed type exhaust valves located in the face of a rotor of rotary engine of this type with individual valves for each working chamber.

Exhaust reed valves are located on the face of the rotor such that the exhaust flow exit from the valve travels radially outward to an exit from the outer periphery of the rotor. The pressure at the exit on the periphery is higher than the pressure at the valve due to centrifugal pumping action.

Locating the inlet and exhaust valves on the face of the rotor, with inlet flow through the shaft and exhaust flow through the outer periphery of the rotor, increases the efficiency of the device by adding a centrifugal pumping effect to a conventional rotary engine of this type. This essentially puts three pumps in series: a centrifugal pomp on the inlet, the rotary engine pump itself and a centrifugal pump on the exhaust or outlet. The invention is applicable to compressors and pumps.

It will be understood by someone skilled in the art that many of the details described above are provided by way of example only and can be varied or omitted without departing from the scope of the invention which is to be interpreted with reference to the following claims.

What is claimed is:

1. A rotary apparatus, comprising:
a stationary stator having an internal cylindrical chamber;
a rotor rotatably mounted in the chamber;
cam-like annular surfaces on the stator to each side of the rotor; and
a plurality of vane assemblies slidably mounted on the rotor, the vane assemblies each having two outer ends which slidingly engage the cam-like annular surfaces, whereby gases between the vane assemblies are compressed and expand between the cam-like surfaces and the rotor as the rotor and vanes rotate relative to the stator, each of the vane assemblies having two separate components, each outer end being on one of the components.

2. The apparatus having a conduit for conducting compressed gases between the two components of each of the vane assemblies and thereby biasing each of the components towards one of the cam-like annular surfaces.

3. The rotary apparatus as claimed in claim 1, having resilient members between the two components of each said vane assembly for biasing the components outwardly away from each other.

4. The rotary apparatus as claimed in claim 1, wherein each said component has an inward side with a recess having an inclined surface and a seal within the recess having an inclined edge slidably engaging the inclined surface.

5. The rotary apparatus as claimed in claim 1, including intake means for conducting intake gases to spaces between the vane assemblies and between the cam-like surfaces and the rotor and exhaust means for conducting exhaust gases away from said spaces.

6. A rotary apparatus, comprising:
a stationary stator having an internal cylindrical chamber;
a rotor rotatably mounted in the chamber;
cam-like annular surfaces on the stator to each side of the rotor; and
a plurality of vane assemblies slidably mounted on the rotor;
intake means for intaking gases into spaces between the vane assemblies, the rotor and the cam-like annular surfaces, the intake means including reed valves mounted on the rotor.

7. The rotary apparatus as claimed in claim 6, having exhaust means for conducting exhaust gases away from said spaces, the exhaust means including reed valves mounted on the rotor.

8. The rotary apparatus as claimed in claim 7, including a drive shaft, the rotor being mounted on the drive shaft for rotation within the chamber of the stator, a conduit extending through the drive shaft for supplying intake gases to the reed valves of the intake means.

9. A rotary apparatus, comprising:
a stationary stator having an internal cylindrical chamber;
a rotor rotatably mounted in the chamber;
cam-like annular surfaces on the stator to each side of the rotor;
a plurality of vane assemblies slidably mounted on the rotor, the vane assemblies each having two outer ends which slidingly engage the cam-like annular surfaces, whereby gases between the vane assemblies are compressed and expand between the cam-like surfaces and the rotor as the rotor and vanes rotate relative to the stator; and
a rotatable annular housing within the stator between the stator and the rotor, the components of the vane assemblies slidably engaging the housing, the housing rotating with the rotor and the vane assemblies.

10. The rotary apparatus as claimed in claim 9, wherein each of the vane assemblies has a radially inner edge and a radially outer edge, the rotatable housing including a portion between the outer edge of each said vane assembly and the stator.

11. The rotary apparatus as claimed in claim 11, wherein the rotatable housing includes a portion between the inner edge of each said vane assembly and the stator.

12. The rotary apparatus as claimed in claim 9, wherein the annular housing has a plurality of slots, each of the slots slidably receiving one of the vane assemblies.

13. A rotary apparatus, comprising:
a stationary stator having an internal cylindrical chamber;
a rotor rotatably mounted in the chamber;
cam-like annular surfaces on the stator to each side of the rotor;
a plurality of vane assemblies slidably mounted on the rotor, the vane assemblies each having two outer ends which slidingly engage the cam-like annular surfaces, whereby gases between the vane assemblies are compressed and expand between the cam-like surfaces and the rotor as the rotor and vanes rotate relative to the stator; and
intake means for conducting intake gases to spaces between the vane assemblies and between the cam-like surfaces and the rotor and exhaust means for conducting exhaust gases away from said spaces, each of the intake and exhaust means including a reed valve.

14. The rotary apparatus as claimed in claim 13, having a rotatable annular housing within the stator between the stator and the rotor, the components of the vane assemblies slidably engaging the housing, the housing rotating with the rotor and vane assemblies.

15. The rotary apparatus as claimed in claim 13, wherein the annular housing has a plurality of slots, the components of each of the vane assemblies being slidably received in one of the slots.

16. The rotary apparatus as claimed in claim 13, wherein each of the vane assemblies has two separate components, each outer end being on one of the components, the apparatus having a conduit for conducting compressed gases between the two components of each of the vane assemblies and thereby biasing each of the components towards one of the cam-like annular surfaces

17. The rotary apparatus as claimed in claim 16, wherein the apparatus includes a drive shaft, the rotor being mounted on the drive shaft for rotation within the chamber of the stator, a conduit extending through the drive shaft for supplying intake gases to the read valve of the intake means.
